(19) United States
(12) Patent Application Publication
(10) Pub. No.: US 2008/0178817 A1
(43) Pub. Date: Jul. 31, 2008

(54) Animal flush toilet and assembly system

(76) Inventor: Marsha Beth Brewer, Appleton, WI (US)

Correspondence Address: MARSHA BETH BREWER, P.O. Box 655, Appleton, WI, 54912-0655, US

(21) Appl. No.: 10/857,753

(22) Filed: May 29, 2004

(51) Int. Cl. A01K 1/01

(52) U.S. Cl. 119/163

(57) ABSTRACT

This modular animal toilet assembly system has portable components, and is flushed by various fluids, gravity, flush valve, and air pressure means to public sewage systems, slurry or septic tanks. Some of the fluids include: water, oil, alcohol, anti-freeze, but are not limited to these. It can discharge into waste disposal means, such as, composting, incinerating, dehydrating, recycling or chemical or mechanical treatment. System components share, standardized, connectable, interfaces. Portable components include: toilet bowl fixture, having drainpipe trap, trap door, or sealing means; animal support platforms, having inserts with variously-shaped apertures, through which wastes pass; pipes for fluid intake and outlet. Platforms with inserts support various animals, while allowing animal waste to pass through apertures via gravity and flushing. Activators for flushing include: manual lever and animal-activated means, such as pressure-activated hydraulic system and photoelectric solenoid sensor system. Water sprayer for additional cleaning is anticipated.

### BACKGROUND AND DESCRIPTION OF INVENTION

1. Field of the Invention

The present invention relates to animal husbandry devices and toilets for the removal of animal wastes, which are accessible and by animals and which clean automatically. It further relates to flush valves to deliver liquids and fluids for flush cleaning with sufficient capacity and energy to clean the toilet and its platforms. It further relates to photoelectric sensors that automatically activate flush cleaning of plumbing fixtures. It further relates to a standardized, indexed edge to provide an assembly system that allows the assembly of varied component modules for customized installations of the toilet.

2. Background of the Invention

The problem is that household pets, such as multiple cats and dogs, confined in homes for extended time periods, need facilities to eliminate bodily wastes. The large number of prior art cat litter boxes and animal toilets indicates that people desired solutions for this problem. There are no toilets that flush automatically and are conveniently useable by animals currently offered for sale. An object of the present invention is an automatically self-cleaning animal toilet that can be installed in water-flush, and other liquid and fluid flush plumbing systems. An object of the invention is to use waste disposal methods typical of current building construction. It is further an object to enable alternate liquids for flushing and alternate waste disposal means. The object of the invention is to eliminate the human labor of supplying litter, disposing and cleaning animal wastes and the ongoing costs of typically-used litter. It is further the object to eliminate the odor, unsanitary mess and continued aggravations from the typical litter box. It is the object of the invention to provide effective cleaning of the animal toilet and automatic cleaning, activated by the animal. It is an object of the invention to provide an assembly system that permits economical, customized installations for varied animal needs, using standardized component parts.

The initial cost is higher for a permanently-installed toilet, designed exclusively for animals, but the assembly system allows economical installation and it accommodates changing, future animal needs. Component modules can be added or changed at a later time. Portable modules can be transported to other locations to adapt the toilet for use by their own animals. People will buy this better-designed toilet system for indoor use in new homes, retrofit in older homes, apartment buildings, hotels that allow pets and public park facilities.

The toilet assembly can be used in outdoor locations by using non-freezing liquids for flushing, such as, but not limited to, recyclable oil or anti-freeze. It can be used with alternate disposal means, such as, but not limited to incinerating, composting or recycling.

The toilet may be useable in commercial settings, such as, but not limited to, the farming of piglets in pens or in the separate housing units provided for farming of calves that are raised for veal.

The present invention combines elements that appeared in prior art. These elements were not combined into one invention in prior art. Prior art devices to enable animals to share human, household toilets were unsatisfactory due to design, inconvenience and access problems. There were also poorly designed water-flush toilet devices for animals. These prior art toilets did not provide a smooth, rounded toilet bowl and a support platform that can be reached and cleaned by flush liquid for automatic cleaning. Another problem in prior art was that the animal support platforms did not confine and orient the animal to avoid deposits in non-flushable places. Much of prior art did not have automatically-activated flushing. The present invention is novel in its combination of elements that appeared separately in prior art, all of which had unsatisfactory design. The present invention additionally provides a novel assembly system that permits economical, customized installations of the animal toilet, using standardized component parts.

In the present invention, the animal is supported above its wastes on a platform or grid. Platforms are a very old concept from animal husbandry that has been used in numerous litter pan devices to keep pellets of absorbent, clay litter dry above a droppings area, urine collection pan or sewage drain. A major problem with non-flushing cat litter pans is the unpleasant smell, even when litter is changed often and deodorant is used. Animals avoid using a toilet or litter pan that has visible wastes, smell or standing areas that are wet. Prior art inventions taught biodegradable litter, flushable litter and non-porous (cleanable) litter. Flushing litter in typical sewage systems tends to clog sewage pipes and fill the systems. Litter pans (non-flush) used the support platform concept from animal husbandry and lower sump container for urine, but not for solid wastes. These devices required manual cleaning by humans.

Prior art did not have support platforms with suitable-sized apertures and reduced surface areas to allow for both the passage of solid wastes and support for animal feet. Some prior art platforms, temporarily attached atop the rim of human toilets to hold litter for training. Prior art animal platforms for human toilets did not clean by automatic water flushing because the platform was not installed within the bowl where it can be reached by the level of flush water. Prior art toilets that were designed with the intent for sole use by animals do not have satisfactory cleaning of the platform area. The liquid sump in a toilet's waste receiving bowl is a main factor to effectively clean solid waste from the receiving bowl. Ideally, there should be minimum platform surface to support the animal, depending on the size of feet and wastes of the animal. Ideally, the platform and bowl could be pre-wetted or under liquid to prevent wastes from sticking. At the least, the receiving bowl and support platform need to be reached by the flush liquid for cleaning, by submersion and by sufficiently forceful liquid action directed at the areas that need to be cleaned.

Litter has been the common means to provide for animal waste. Prior inventions teach manual and mechanical means to sieve solid wastes from litter, Liquid wastes can collect in a lower, sump container by passing through a grid platform. (Clumping clay litter enabled a human to manually sieve solidified wet litter and solid wastes). Clay litter dust is a lung health hazard for animals. Litter is a collecting place for bacteria and parasites. Less toxic and biodegradable litter has been made from plant products, such as alfalfa and corn but must still be handled by humans. Some prior art devices teach washable, non-absorbent litter for reuse, such as plastic or plastic-coated iron pellets, that are agitated by magnets. Complex prior art inventions agitate, macerate wastes, wash and reuse permanent litter.

The inventor of the present invention observed that cats (and other animals) don't need litter. Cats will use a human toilet, sink or bathtub for excretion, but will only do so when the location is clean. Cats will use their customary litter pan, without litter, if it is clean. Cats will use a visibly clean, odor-free, dry habitual waste deposit location if it provides sufficient support for feet and cleanliness. Cats may be able to stand on the toilet seat platform of a toilet that is designed for humans, but the cat is not properly oriented to deposit wastes into the toilet seat's aperture. If a cat falls into the water it is less likely to use the toilet again. Small, young and infirm cats would have more difficulties with mounting and falling in. The inventor noted that other pet animals, such as, but not limited to, ferrets, hamsters, pigs, and rabbits will eliminate wastes at a customary location without litter, such that they could use a suitably-configured toilet.

Old prior art inventions, for children and animals, teach adjustments to the aperture size of a toilet seat. Prior art dual, human-animal-use devices sit atop the rim of a toilet, such that they are not reached by flush water for automatic, flush cleaning. Prior art requires manual cleaning to adequately clean the platform areas. Some prior art adapting human toilets are supported by legs or hooks, in a manner that puts the platform within the toilet bowl, but these do not provide satisfactory automatic, liquid flush cleaning of the platform areas. Pre-wetting or water in the waste receiving receptacle (bowl) keeps the bowl cleaner in the present invention.

No prior art combines all separate elements into one invention that provides a satisfactory platform and satisfactory cleaning, despite prior art attempts to provide water-flush cleaning for animals. The elements of the present invention are the following: support platform grid with aperture(s) (without litter) or with training devices (that may contain litter or scent), a device with makes the platform and waste receiving bowl pre-wetted or reachable by automatic liquid flushing for cleaning, adequate orientation of the animal over the platform's aperture(s) areas, sufficient liquid flushing force to clean the platform, and automatic activation of flushing, and fixture attachment to standard plumbing disposal systems to provide water inlet and discharge, and a satisfactory seal from sewage gas. Alternate flush liquids are anticipated. The above elements are taught separately in prior art, but were not combined into one satisfactory invention. The present invention remedies function and design problems in prior art.

No prior art animal toilets had the novel standardized, assembly system that enables customized, economical installations using standardized components. It is this assembly system that enables a standard installation in building construction. The assembly system enables one to adapt the toilet for later use by numerous types of animals. A standardized animal toilet would be recognized and used by animals in public locations, such as apartment buildings, hotels that allow pets, urban streets and parks. The assembly system of the present invention enables installation of varied component modules for platforms to support animals. All component modules have a standard, indexed, integrally-molded, mating edge that fits the modules together in this assembly system. The edge system of the present invention enables easy, customized, flexible, economical installation of a variety of platform inserts for varied configurations of aperture size to accommodate size of wastes and feet, animal size and to accommodate training devices.

Sufficient flush force for cleaning a specific toilet design is mechanically complex. It is achieved by forces of height and gravity on flush liquid, volume of liquid, volume and shape of bowl, and shape of the u-shaped trap. (The u-shaped trap is the standard method to block noxious gas escaping from waste disposal systems). The u-shaped trap has a trapway outlet that is wider than its trap to help to create suction-force or vacuum from below to pull wastes out of the toilet fixture. Commercially-available flush valves provide a range of adjustment to govern the amount of water force, flushing energy and pressure from the water supply. There must be sufficient pressure in the water supply. The present invention's shape and configuration of inlet holes in the toilet bowl fixture and platform modules are designed to increase the amount of force and energy from the flushing liquid for better cleaning. Prior art animal toilets lacked sufficient pre-wetting and force of spraying to be effective at automatic cleaning of their platform areas.

The assembly system of the present invention is particularly useful and novel because the standardized, indexed system enables customized assembly to suit various owner preferences and various animal characteristics, which makes manufacture and permanent installation more practicable. The platform grid in the present invention fits and is supported on an integrally-molded, mated, indexed ledge within the toilet bowl, barely above the liquid level in the bowl. The automatic, photoelectric activation (which can be timed for delayed flush) causes pressurized flush water over the grid by the flush valve. Elliptical-shaped, angled holes within the rim channel of the bowl direct the flush liquid to achieve greater force. (These holes help to create vortex water action to improve cleaning.)

The design of prior art animal toilets does not clean solid wastes well as the present invention. A flush valve pressurizes and increases the energy of flush water for improved cleaning. The geometry of the trapway of the discharge passageway and the placement and shape of the inlet holes for flush liquid improve cleaning of this fixture, Solid bodily wastes do not float, contrary to statements in some of the prior art; solid wastes sink. Prior art does not specify a smooth, round bowl with maximum water area, elliptical, angled rim-holes and flush valve for best cleaning.

Water flush toilets, such as the present invention, operate by a combination of forces: 1) gravity-pressure from above and 2) suction in the sewage outlet passageway. (The common U-shaped trap is a simple water blockage that prevents toxic sewer gas from entering the building). The top pressure comes from an interaction of forces: pressurized water (it could be pressured by air tank or flush valve), water volume, gravity and height of the water in the storage closet. The flush valve is ideal because it creates an adjustable range of water pressure and eliminates the need for a water storage closet in a small location. (A flush valve requires one-inch water inlet pipe and sufficient pressure in the water supply). The toilet's lower suction force comes from siphon or suction force in the trap and its wider outlet passageway. Cleaning of the toilet bowl of the present invention is improved by having more water surface area in the bowl covering the inside of the fixture and by the vortex force. Prior animal toilet art does not have these features. Prior art combined a variety of mechanical and photoelectric means of activation.

The indexed, assembly system of the invention is novel and allows the addition of customized, grids and screens with various apertures for small animals, having differing sizes of feet and excrements. Training inserts with temporary training litter and a method for behavior modification are taught in prior art. Prior art did not use an assembly system that provides for flexible combining of standardized component modules. The present toilet assembly system is a better-designed toilet fixture. The standardized, indexed edge of this assembly system also enables larger support platforms for large animals. Prior art describes large animal platforms, having grooves and slopes toward a waste aperture, but without the indexing edge to assemble with a standardized toilet fixture. The assembly system allows differing, future pets to use the same, permanently installed toilet in a home, apartment or hotel. It enables owners to add customized components to standard animal toilet fixtures in apartment buildings and hotels. The toilet facilities would be recognized by animals that become familiarized with the toilet in another setting.

The benefits of this animal toilet for pet owners are savings in the costs of litter, cleaning time and aggravation. Treating sewage is more favorable to the environment than is filling landfills with litter. Many animals are abandoned at animal shelters because they eliminate wastes in wrong areas of the home. The toilet will save animal lives. The animal toilet will permit people, who are not able to take animals out for elimination, for whatever reasons (infirmity, time, safety, etc.), to be able to enjoy the pleasures and benefits of having pets.

Toilets are an old art. The market for replacements for water-flush toilets is largely a replacement market in the United States, rather than a growth market. More recent improvements to toilet art include electronic activation of flushing and water conservation means. I hope that the manufacture of this new and useful product will provide a useful product to people and their animals. I also hope it provides employment in the businesses of the manufacture of toilet-related items and plumbing labor in the United States and elsewhere.

### DESCRIPTION MATERIALS INCLUDED

Drawings (In enclosed envelope on Strathmore Board)

### Numbered Parts List

### Description of the Drawings

### Brief Description of the Operation

### Brief Listing of Prior Art

In the enclosed drawings, like numbers refer to like parts and to the Numbered Parts List.

### NUMBERED PARTS LIST

22 Toilet Bowl Fixture Module
23 Toilet Bowl Rim, perimeter of top aperture of waste receiving Means
24 Grid Rack Platform Module for small animals, such as cats
25 Bowl or receptacle to receive wastes in Toilet Fixture 22
26 Index Ledge Interface of assembly system, integrally molded into Bowl 25 interior surface of Toilet Fixture 22 to extend functionally around perimeter of bowl or receiving means for the purpose of receiving and supporting Edge 48 of all standardized Platforms of the assembly system
28 Inlet jets, elliptical and angled to direct a vortex of clean, flush-water across platform modules
30 Splash Guard Module
32 Alternative Splash Guard Module
34 Aperture installation location for photoelectric solenoid sensor
36 Bolts to secure Splash Guard Module and Platform Module to mated, threaded nut receptacles in Rim 23 of Toilet 22
38 Nut receptacles, mated and threaded for Bolts 36 in Rim 23
40 Water Sprayer on flexible hose with hand-operated valve (option)
42 Water Sprayer attachment
44 Bolts and washers to secure Toilet Fixture 22 to the floor so that the Waste Outlet 62 is mated with Standard Plumbing Flange 60 of a prepared location
46 Training Insert with Edge 48, which mates with both Index Ledge of Bowl 25 and also conforms to Platform 24, which has an Edge numbered 48 in the assembly system
48 Standardized Edge or outer rim of all Platform and Insert Modules that mate with Index Ledge numbered 26 of Bowl 25
50 Prepared Standard Location for a floor-mounted Toilet 22 fixture (Wall-Mounted Unit is Also Possible.)
52 One-inch diameter Inlet Pipe for clean water supply
54 Flush valve control with threaded or soldered coupling
56 Standard Sewage Stack Pipe in prepared location
58 Standard Donut-shaped Wax Seal to seal Discharge Outlet 62 Of Toilet 22
62 Discharge Outlet, a standard, tapered coupling of Toilet 22, which mates with the trap discharge passageway, connecting Bowl 25 with Floor Flange 60 of the prepared standard location
64 Flush Valve module, for water flush embodiment from Sloan Valve Co.
66 Pipe Fitting, threaded or soldered to connect water supply Valve 54 with one-inch Water Inlet Pipe 68
68 Water Supply Pipe, which is one inch or more in diameter
70 Pipe Fitting, which or soldered to connect Water Supply Pipe 68 and And flush Valve Fitting 72
72 Fitting, which is threaded or soldered to connect Flush Valve Module 74 and Fitting 70 on Water supply Pipe 68
74 Standard Flush Valve for commercial toilets (Sloan Valve)
76 Output Fitting of Flush Valve 74
78 Fitting, a threaded or soldered coupling to mate flush valve Output Fitting 76 to one-inch pipe
80 Fitting, a threaded or soldered coupling to mate Intake fitting 82 to one-inch pipe
82 Water Inlet Fitting of Toilet 2
84 Activation Module for the Flush Cycle (Sloan Valve photoelectric)
86 Electric power source
88 Switch
90 Electrical connectors between Circuit 92 and power Source 86
92 Electrical Circuit with standard, insulated copper wires
94 Standard electrical plug connectors which connect Flush Valve 74 with Circuit 92 and Switch 88
96 Alternative Platform for large animal, with Edge 48, which mates with Index Ledge 26 of Bowl 25 of Toilet 22 in the assembly system
98 Cover for Prepared location 50 when Toilet 22 is not installed
100 Alternate Insert with Edge 48 for platform 96 for large animal
102 Alternate Platform or Insert with Edge 48
103 Alternate Platform or Insert with Edge 48

### BRIEF DESCRIPTION OF THE DRAWINGS (FOR PREFERRED WATER FLUSH MODEL)

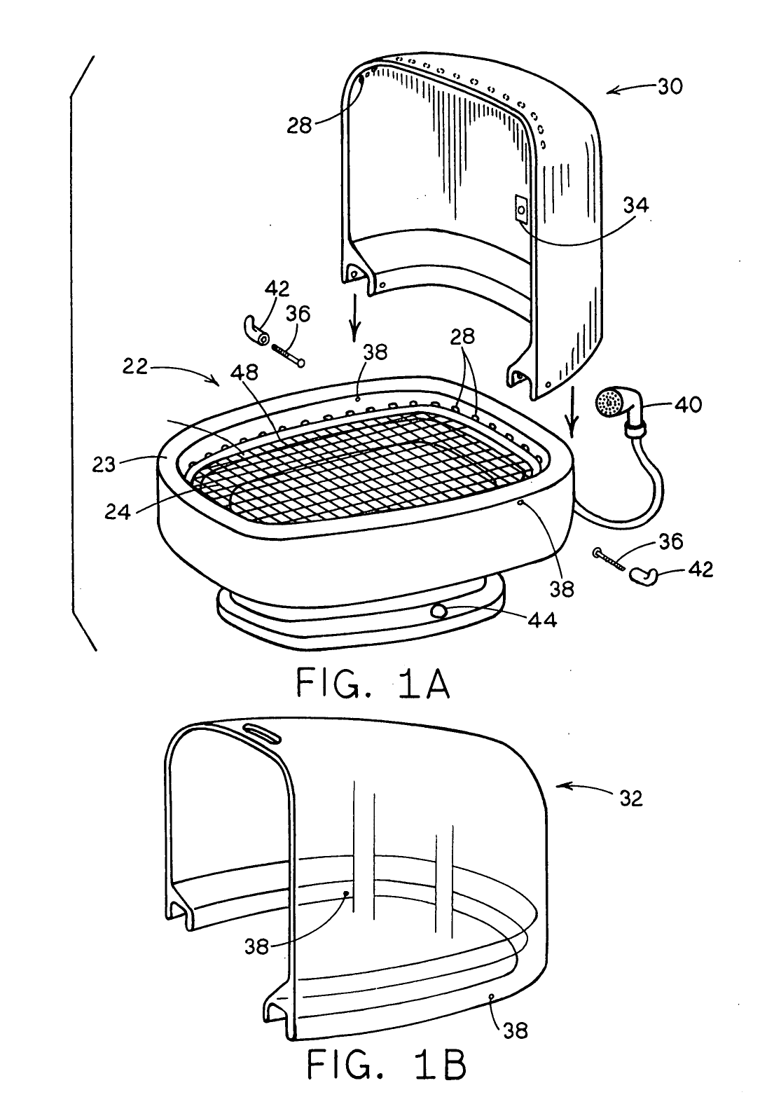

FIG. 1A is a front pictorial view of the toilet bowl fixture for a preferred water flush embodiment with a platform grid for a small pet and a splashguard installed. (Note: other flush fluids can be used).

FIG. 1B shows an alternative splashguard.

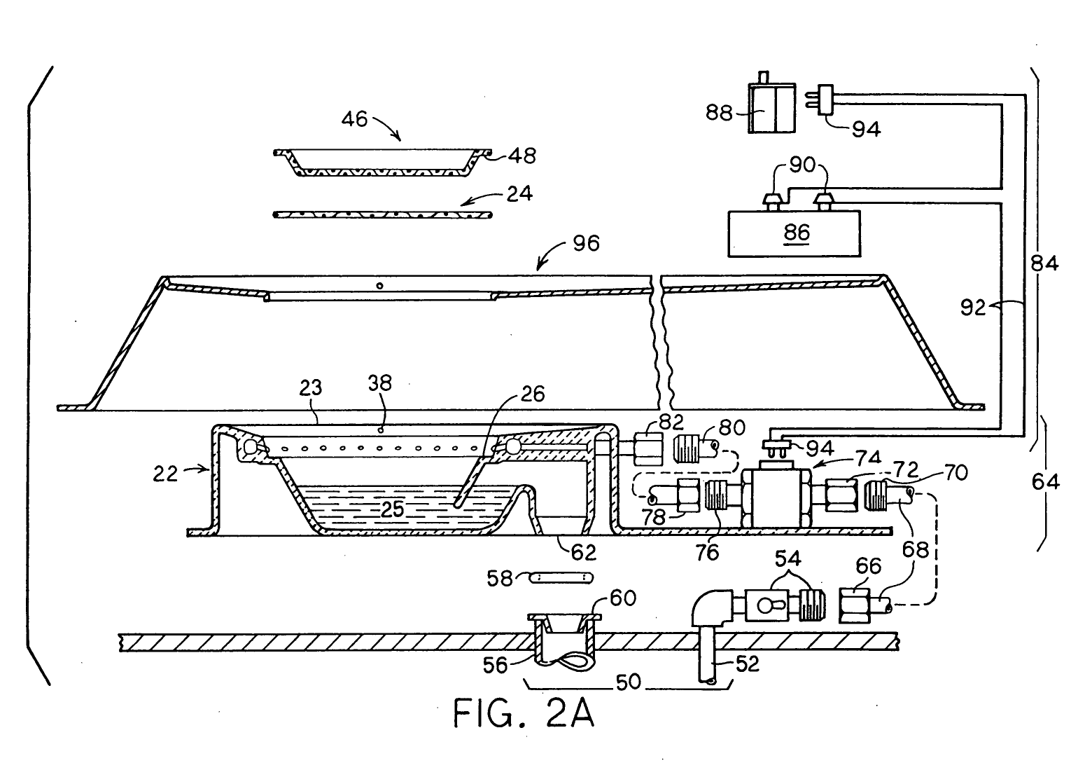

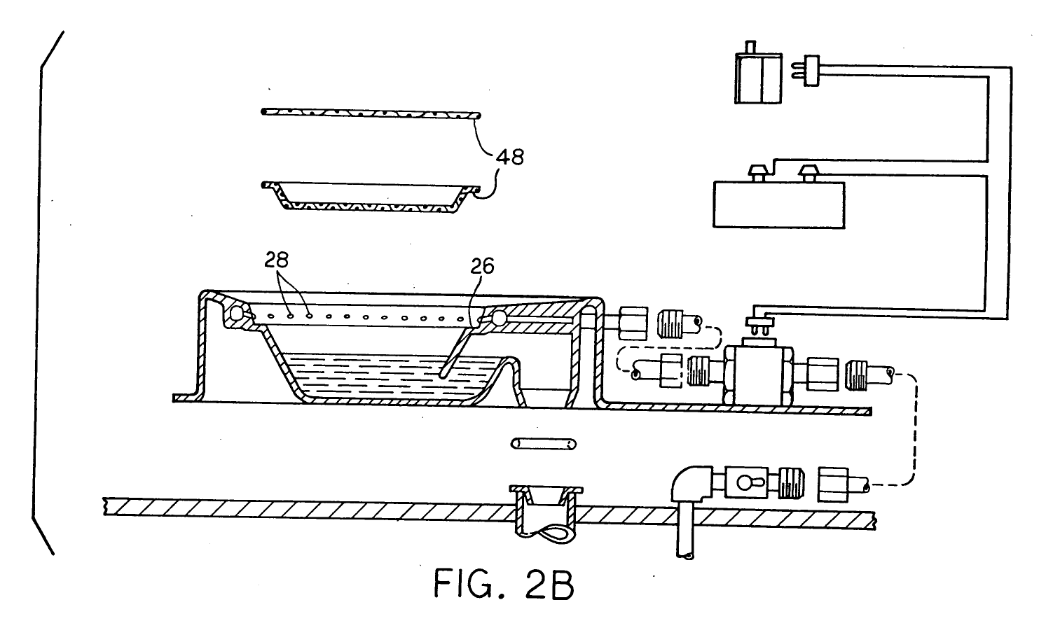

FIG. 2A is an exploded pictorial schematic drawing of the toilet system showing electrical and flush valve connections. Shown with a platform for a large animal. (Proportions have been changed for ease of illustration).

FIG. 2B is an exploded pictorial schematic drawing of the toilet system of FIG. 2A, with a platform for a small pet animal.

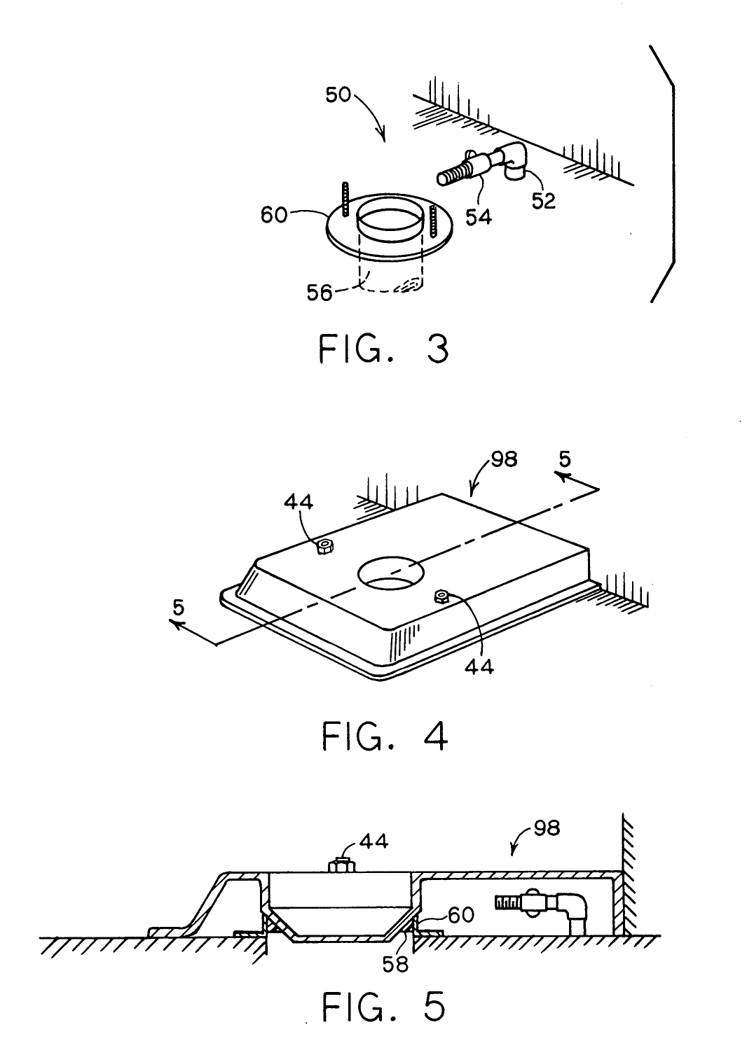

FIG. 3 is a pictorial drawing showing a standard location prepared to receive the water flush embodiment of the toilet FIG. 4 is a pictorial view of the cover for the standard prepared location when the toilet fixture is not installed

FIG. 5 is a sectioned elevation view of the cover of FIG. 4.

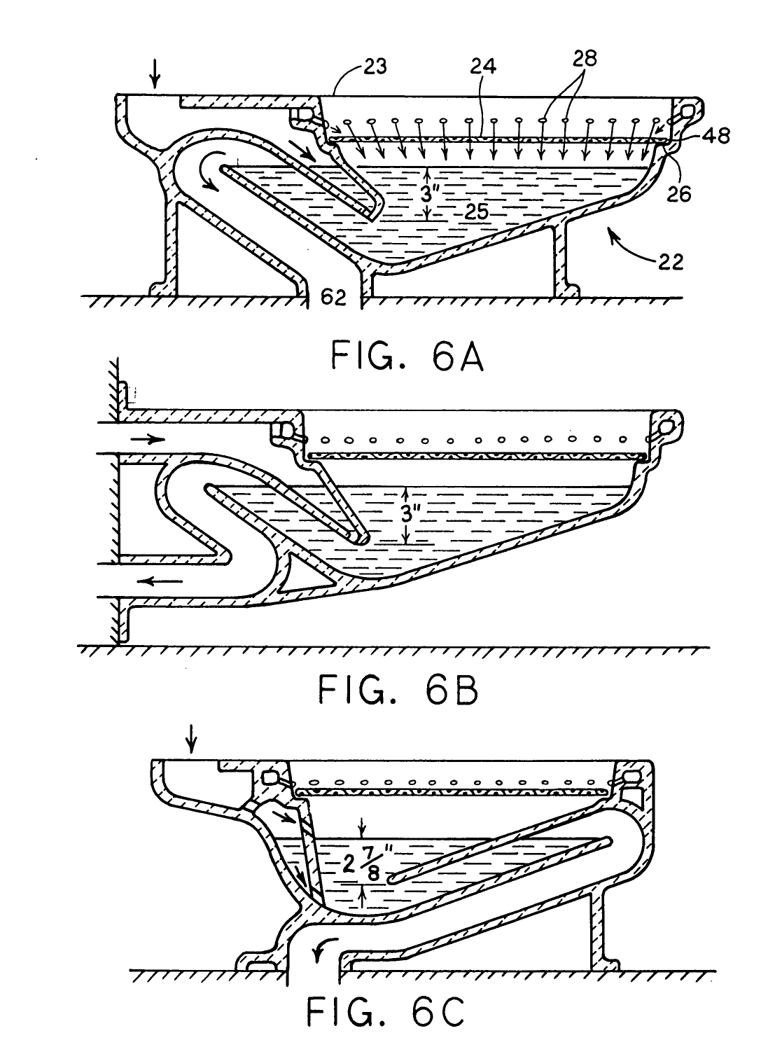

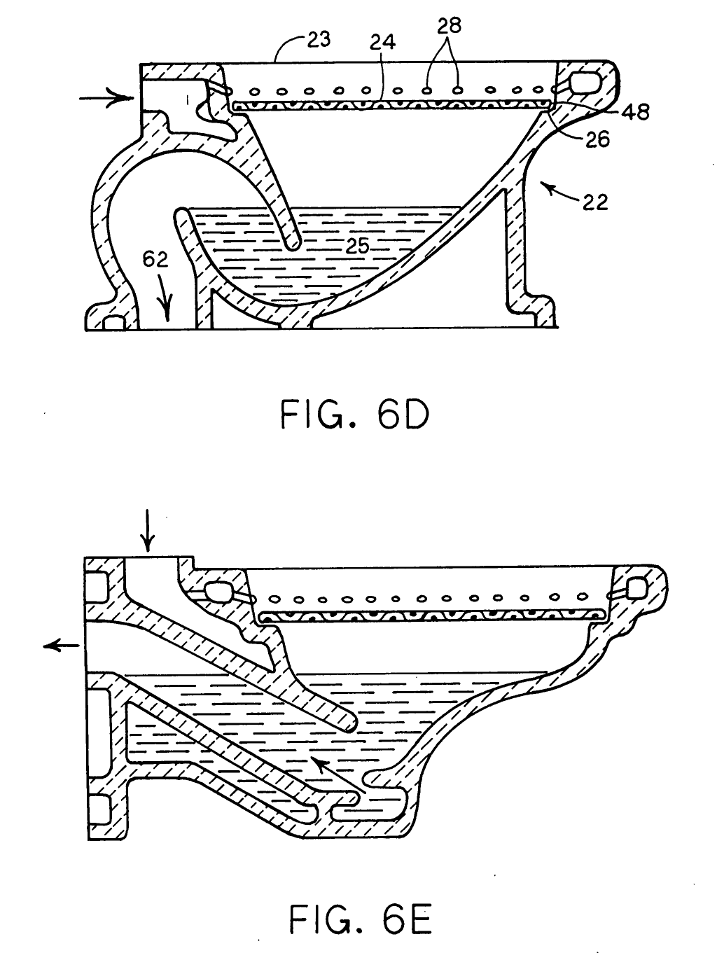

FIG. 6A through 6E show cross-sectional, elevation views of various conventional internal toilet structures, bowl, trap and trapway, waste discharge outlet passageways, which operate in the liquid flush embodiment of the toilet

FIG. 6A is a cross-sectional, elevation view of the floor-mounted toilet fixture with a siphon jet structure in the waste outlet passageway.

FIG. 6B is a cross-sectional, elevation view of a wall-hung toilet fixture with a reverse trap waste outlet passageway.

FIG. 6C is a cross-sectional, elevation view of a floor-mounted toilet fixture with a siphon jet structure in the waste outlet passageway.

FIG. 6D is a cross-sectional, elevation view of a floor-mounted toilet with a washout bowl trap structure and larger waste outlet passageway, perhaps for commercial use

FIG. 6E is a cross-sectional, elevation view of a wall-hung toilet fixture with a blowout bowl trap structure, larger water surface area and larger waste discharge outlet passageway.

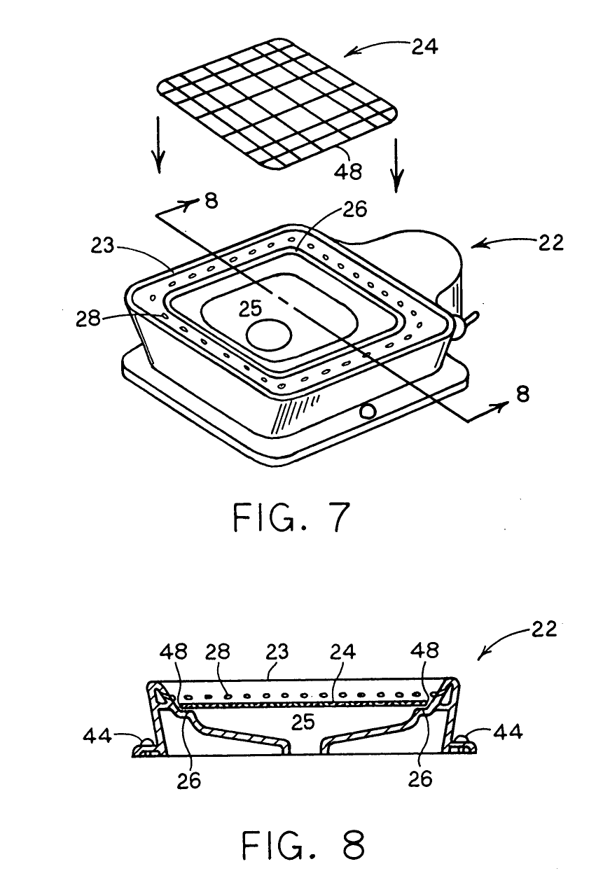

FIG. 7 is a top pictorial view of a square-shaped illustration of the standardized, indexed assembly Ledge 26, which receives and supports various platform and training insert modules, having Edge 48 and which positions the platform below water flushing jets, but above the reservoir water in the bowl

FIG. 8 is a cross-sectional, elevation view of the toilet bowl fixture of FIG. 7, which illustrates the standardized, indexed assembly system, rim, bowl, water jets and waste discharge outlet.

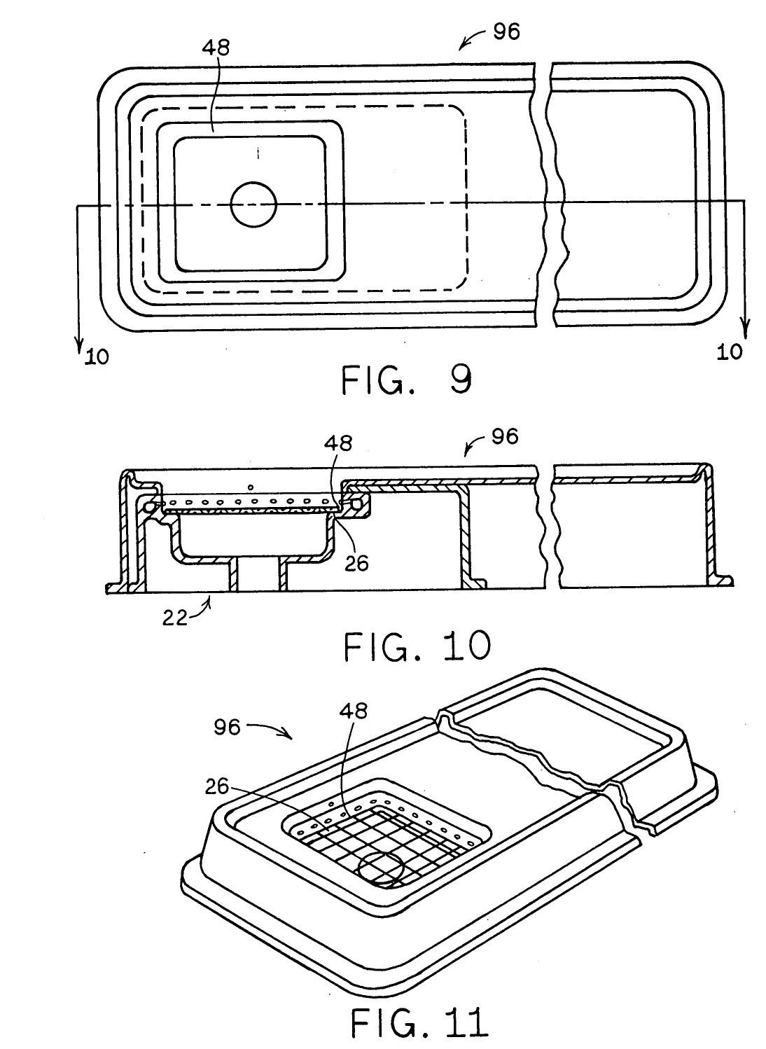

FIG. 9 is a plan view of a large animal platform module that is indexed to the toilet fixture.

FIG. 10 is a cross-sectional elevation view of the platform of FIG. 9, showing the indexed interface of Toilet Ledge 26 and Platform Edge 48.

FIG. 11 is a top pictorial view of the platform of FIGS. 9 and 10 with an insert component installed in the platform's aperture.

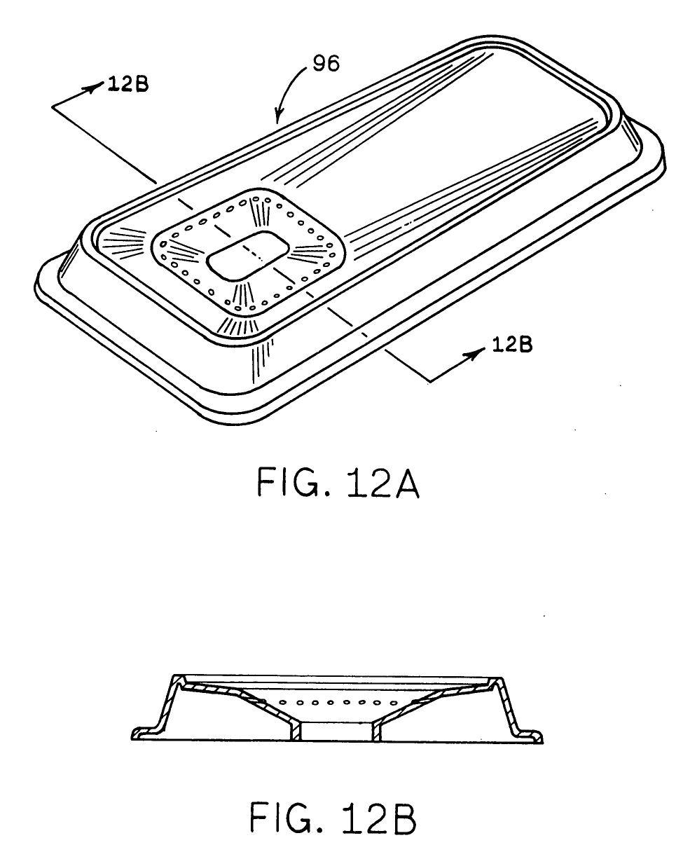

FIG. 12A is a top pictorial view of an alternative large animal platform. It contains inlets for fluid flushing.

FIG. 12B is a cross-sectional, elevation view of the platform of FIG. 12A.

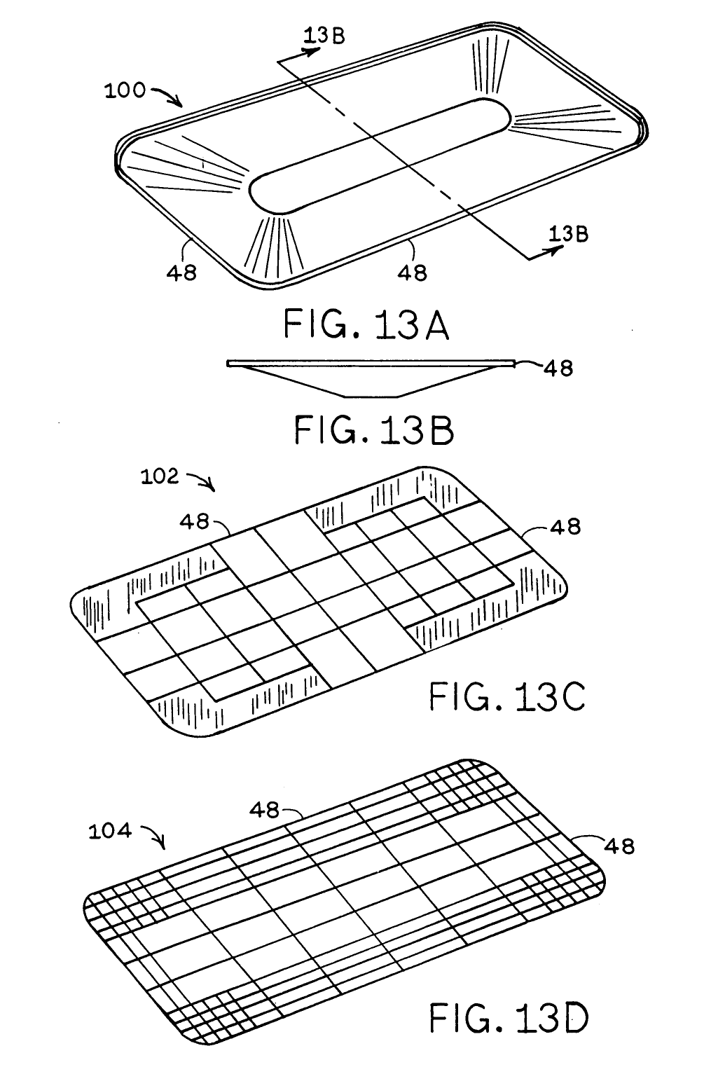

FIG. 13A through 13D illustrate several inserts with various configurations of apertures.

FIG. 13B is a cross-sectional, elevation view of FIG. 13A.

FIG. 13C is a top pictorial view of an alternative insert, having a wire, rod or grid with multiple apertures. A plastic, screen, fiber, or paper training insert can be supported upon the grid to reduce aperture size or to contain litter for training purposes.

FIG. 13D is a top pictorial view of an alternative insert with another configuration of multiple apertures.

### DETAILED DESCRIPTION OF ILLUSTRATED EMBODIMENTS

In the drawings, like numbers refer to like objects. The proportions of some elements have been changed for ease of illustration.

Referring now to FIG. 1. FIG. 1 is a pictorial drawing of a 22 toilet bowl with a 24 grid platform installed in the standardized 26 index edge of the assembly system. Views of two splashguards show their attachment to the toilet fixture. The toilet is bolted to the floor to secure the standard-sized water inlet and sewage outlet openings. There is a standard, prepared location for all animal toilets of the present invention. This Figure shows an additional clean water source from a water faucet with a sprayer on a flexible hose.

FIGS. 2A and 2B provide simplified representations of typical component modules that combine in the assembly system. These Figures show interface relationships and are not intended to be accurate as to relative sizes, shapes and locations. FIG. 2A is a large, sturdy platform for a large animal, with a model of the toilet fixture, having a washout or blowout internal structure. FIG. 2B is a toilet with a smaller platform and a toilet bowl with a reverse trap or siphon jet types of internal structures. The owner can combine various modules to assemble a flushable animal toilet that meets his changing needs. Platforms can be moved to different locations and changed for use by different animals. The essential components are in FIGS. 1 and 2.

In the typical installation of the preferred water flush mode, the prepared location 50 has a water input 52 and a waste discharge 56. Clean water supply is provided with standard one or one-half inch inlet pipe and coupling 54. Waste discharge 12 is provided with standard plumbing toilet closet floor flange 60. It is important that the location be standardized to use typical plumbing parts and to permit installation for future and changing animal needs.

Toilet 2 is provided with the standard tapered waste outlet coupling 62, which mates with standard floor flange 60 and the two are maintained in engagement by standard brass, threaded toilet closet bolts and nuts and washers. Seal against leaks is maintained by a standard plumbing donut-shaped wax or plastic seal 58. Toilet 22 has a standard clean water inlet 52. Toilet 2 is configured to be low and broad to cooperate with a platform 24, upon which an animal can conveniently mount and stand. Toilet 2 has a platform index ledge 26 which mates with a reciprocal platform edge 48 to keep the edges of the component modules in position relative to each other. Platform 4 is configured to transmit a portion of the weight of the animal directly onto the floor to reduce the load on the toilet fixture. Platform 4 has, as an integral part of its construction, a molded edge 19 to interface with and receive training insert 5. The platform is made of durable material, which is impervious to stains and odor. Suitable materials include, but are not limited to, stainless steel, molded metals, ceramic or plastic or fiberglass or a grid rack of stainless steel or heavy wire, which could be coated with plastic or rubber.

The preferred mode for flush unit 64 is a standard, commercially available plumbing flush valve. Water inlet pipe 11 is joined to the flush unit by means of a first coupling 22, which has fittings to mate with pipe coupling 13. the flush unit is joined to the toilet fixture by means of a second coupling tube which mates with output fitting 21.

The flushing cycle is initiated by an activation means 84. The preferred mode is an electric solenoid cell sensor. In FIG. 2, activation means 84 is shown as an electrical means, having an electrical power source 86 and a switch. The power source has standard electrical connectors 90, which provide electricity to the circuit 92. The circuit has standard electrical connectors 25 to join switch 9 and flush unit 3.

The prepared location 1 is standard for all floor-mounted animal toilets of this invention. This enables the location to be built into new homes in anticipation of unknown, future animal needs. Toilet 2 will ordinarily be of a standard size to serve typical household pets. Platforms 4 are later installed to suit the specific needs of animal that will use the toilet. Training insert 5 is installed to meet specific needs of animals.

Referring now to FIGS. 3 through 5. The prepared location is standardized and defined in detail for the toilet system. The toilet fixture is configured to interface with the prepared standard location. Flange 14 is a standard-sized plumbing toilet closet flange 14 on a drainpipe, leading to the main sewage disposal waste stack pipe. There is a standard clean water input connection. The toilet fixture model could be floor-mounted or wall-hung for easy cleaning, provided that the animal's weight does not exceed the limits of the wall attachment.

The type of drainpipe determines the type of floor flange. Lead drain stubs require brass or hard lead flanges that are soldered to the stub. A copper drain stub requires a brass flange soldered to the stub. A cast iron drain stub requires a cast iron flange, with a lead and oakum joint. With a plastic drain stub, a plastic flange is cemented to the pipe. The toilet outlet flange slides down over the stub until it rests level with the floor. Stubs that extend above the top of the toilet outlet flange must be broken off or cut flush with a hacksaw. Two brass toilet closet flange bolts, with threaded ends up, secure the fixture to the floor with standard nuts and washers. With wood floors, the bolts screw into the floor and a lead shield is used to protect the floor.

When the standard location is not in use, it can be covered with a cover 30, which is secured to the floor and sealed against sewer gas. The standard site could be installed in new construction in anticipation of future pets.

Referring now to FIGS. 6A through 6E, which show various internal structures for trap outlet passageways which will work in the toilet. FIGS. 6A and 6B are siphon-jet and reverse trap passageways that flush well. FIG. 6C is a wall-hung installation with siphon-jet and reverse trap passageways. Metal carriers in the wall support the wallhung toilet. FIG. 6D is a washout bowl type, which has stronger construction and a larger trap outlet passageway for large amounts of wastes. Its discharge passageway can be accessed for manual unclogging. Flushing of the washout passageway depends entirely on water force, and not on siphon forces. FIG. 6E is a wall-hung blowout bowl type. Its flushing depends on the driving force of water forced through jet outlets in the rim, rather than on siphon action. It has a large water surface area and deep seal. It is noisier and requires more water pressure.

Referring now to FIGS. 7 and 8 of the Toilet 2 fixture. The toilet fixture has a tapered waste outlet interface 32, which mates with a standard floor flange 14 of a prepared location. Toilet 2 is secured to floor flange 14 by brass bolts 31, passing through holes 35. Toilet 2 has a standard water input fitting 33, connecting it with a flush valve unit 3. Toilet 2 has a standard indexed ledge mated for the assembly platforms and training device in the assembly system of this invention. This ledge is an integrally-molded part of the interior toilet bowl construction, at water level, when the toilet is in a neutral water-filled state.

All toilet trap passageways structures in FIGS. 6A through 6E and in FIGS. 8 and 8 can be flushed with a commercially-available flush valve. The depth of the water seal in the bowl is three inches. The water surface area is the bowl is approximately 12 by 15 inches. The diameter of the outlet passageway at the outlet end is approximately 2 and one-half inches.

Referring to FIGS. 9 through 12. Platform 4 has a depressed lip edge that conforms to the size and geometric shape of the platform ledge in Toilet 2. The rim of Toilet 2 is beveled to slope toward the toilet bowl's central aperture. Platform 4 is shown in FIGS. 9 and 10 as a free-standing platform. A non-free-standing platform is shown in FIG. 11.

Training insert 5 shows the versatile combinations that are possible with this component module. Inserts 40 are shown in FIGS. 13A through 13C. Training inserts could include, but are not limited to, a clear plastic bowl, a metal or plastic mesh screen, and disposable paper or fiber inserts, which could be impregnated with attractant scents or deodorants. A standard installation for adult, small house pets is a stainless steel, rigid wire grid with openings one to two inches apart. This would support the paws, while allowing urine and fairly large solid wastes to pass through by gravity into the water in the toilet bowl. A small kitten or rabbit may require smaller openings, which can be achieved with an insert, such as a screen of woven wire or plastic.

To set forth the number and variety of all enhancements for platforms and training inserts that are enabled by this assembly system would greatly multiply the drawings. Therefore, it should be understood that, while enhancements may not be specifically illustrated, the inventor anticipates and recommends these enhancements within the claims of the present invention. Those skilled in the art will see that certain modifications can be made to the apparatus and methods disclosed herein, without departing from the spirit of the present invention. The preferred embodiment was described, but it can be understood that the invention can be adapted to numerous rearrangements, modifications and alterations, and all of these are within the intended scope of these claims.

### Description of Operation of the Preferred Water Flush Mode:

The preferred mode of cleaning for the toilet assembly installation for a cat or small pet in a home with electricity and water is a flush valve. There may be limited space for a water reservoir closet in locations where the toilet will be installed. Flush valves are more costly and more common in commercial settings, but the advantages of the flush valve are many: more rapid repeat use, better bowl-cleaning because there is more energy and water pressure produced by a flush valve than by gravity and siphon forces, simple mechanical adjustment to govern a range of adjustment. Disadvantages of a flush valve include: higher initial cost, more noise during flushing, need for adequate water pressure in the supply (A sustained 15 pounds or more of water pressure in the municipal system and one-inch water supply inlet pipe are adequate. A larger sewage outlet pipe would reduce noise.)

Flush valves can be set to deliver the amount of water to meet the United States federal regulation to achieve water conservation. The current standard of water use for toilets for humans is to use no more than 1.6 gallons per flush. The preferred flush liquid in an indoor, home setting is water, with a waste discharge to home plumbing and sewage disposal system. In an outdoor setting, other flush liquids may be desired to prevent freezing. Suitable other liquids for flushing can include, but are not limited to, alcohols, anti-freeze or light oil in a recyclable system, in which wastes may be separated by specific gravity. Traditional waste disposal systems, such as, but not limited to, septic systems and slurry tank systems could also be used. The toilet assembly could discharge wastes to unconventional waste disposal systems, such as, but not limited to incinerating or composting systems.

Automatic activation of liquid flushing of plumbing fixtures can be initiated by directing the weight of the animal on the platform to a button that triggers hydraulic operation of a flush valve. The preferred mode of operation (with available electricity) is activation by an electronic solenoid (“electric eye”) sensor. Commercially available flush valves and solenoid sensors include, but are not limited to those sold by Sloan Valve Co. of Franklin Park, Ill. Sloan hydraulic and electronic sensors and flush valves are under U.S. Pat. Nos. 3,308,347; 3,273,919; 3,334,646; 3,556,137; 4,309,781; 3,533,555.

In the preferred embodiment, a flush valve to force water through the toilet fixture is automatically activated by the solenoid cell sensor. When the animal leaves the area sensed by the sensor, which interrupts the electric circuit, the sensor electrically triggers a switch on the flush valve to cause it to flush.

The flushing action of a toilet is like that of a syphon. A decrease in atmospheric pressure at the trapway outlet of the trap passageway causes part of the flushing forces. When the toilet is in a neutral position and is not flushing, there is water standing in the u-shaped trap. A u-shaped trap is the most common and reliable method in plumbing art to form a seal to prevent noxious sewer gas from entering a building. In the neutral and ready condition, the atmospheric pressure is the same on both sides of the trap. The diameter of the outlet or trapway end of the trap is smaller than that of its inlet end. This and the short turns within the passageway slow the flushing liquid and cause a head of water and pressure to build up in the upper toilet bowl. When the toilet bowl is flushed, the water passing through the trap passageway eliminates the air and pressure balance. This produces a partial vacuum on the outlet end of the trap. Atmospheric pressure combined with the head of water on the inlet side of the trap force wastes from the toilet fixture into the sewage pipe. Flush action is a combination of downward force from above and sucking (siphon) force from below. After the level of water in the bowl has dropped, air can again enter the toilet's outlet passageway. This air breaks the syphon action, and it causes the flushing to stop.

It is noted that the toilet fixture and assembly system modules of this invention can be adapted for use with other liquids for flushing and mechanical or trap door means of waste discharge from the toilet system.

In the preferred water flush mode, the toilet bowl, while in its neutral position, contains three inches of water, so that it is filled properly to receive wastes. This pre-wets the bowl and prevents incoming wastes from sticking to the bowl. This standing water also causes the u-shaped trap passageway to be filled so that it can seal against noxious sewer gas.

When flushing begins, water starts to enter the toilet fixture and is forced through elliptical inlet holds along the rim channel. (On installations with splashguard or large animal platforms, flush liquid is forced through inlet holes in these modules).

The shape, geometry, and volume of the toilet fixture and the water pressure from the water supply affect whether a given toilet design will flush well. The elliptical shape of the inlets in the rim channel of the present invention also acts to increase flush liquid's force. Commercially-available flush valves have a simple screw-type adjustment to regulate the volume of flow and pressure. Thus a typical flush valve can compensate for variations in the water supply's pressure and for variation in toilet designs that are enabled by the present invention. The floor-mounted variation of this animal toilet requires at least 15 pounds of sustained pressure to flush. In some situations, such as a wall mount or blow-out embodiments, 20-25 pounds of pressure may be required to clean the toilet. A smaller animal with small waste amounts could use less water and less force to effectively flush the toilet clean.

The flush valve can be installed at various locations on this animal toilet, including on top of the fixture, within a wall on a double-walled fixture, or more remotely located, such as in a wall of the building. The water supply pipe must be one inch or more in diameter for the commercially-available flush valves to operate. Homes tend to have one-half inch water supply piping to save costs. The pipe can be replaced with the larger sized pipe. Commercial locations commonly install one-inch pipe. The water pressure in the municipal water supply must be sufficient to supply a sustained volume and pressure of water.

The entire plumbing system of the building must have sufficient ventilation and air pressure to be adequate for all of the plumbing fixtures that are installed in that building. This promotes proper flushing of toilets and prevents sewage backups and toxic gases from entering the building. The water pipe sizes and flange sizes for sewage outlet pipes that are specified for this invention are standard sizes for current, typical plumbing. It is recommended that a licensed plumber install the animal toilet according to the requirements of government building codes. The installer must follow building codes respecting amount of flow through and proper ventilation to maintain proper atmospheric pressure in the system.

### Listing of Pertinent Prior Art

(The search did not include a search of foreign patents. The inventor believes there may be French, German, Dutch and Canadian patents for animal toilets). This search was updated in May 2004.

Support Platforms and Screens that Allow Wastes to Drop by Gravity Beneath Animals or Humans:

| | | |
|---|---|---|
| 20030051672 | Gordon | March 2003 |
| 20030116095 | Otsuji | June 2003 |
| 20040089243 | Chiu | May 2004 |
| 20020089243 | Chiu | June 2002 |
| 20010027753 | Ball | October 2001 |
| 6,615,765 | Thomas | September 2003 |
| 6,523,495 | Rydman | February 2003 |
| 6,408,790 | Maguire | June 2002 |
| 5,699,754 | Cahijia | December 1997 |
| 5,699,638 | Thornton | April 1995 |
| 4,098,229 | Haynes | June 1976 |
| 3,435,464 | Harding | 4//1969 (for human use) |
| 3,430,269 | Bradshaw | March 1969 |
| 3,339,527 | Burroughs | September 1967 |
| 3,289,214 | Corliss | July 1964 |
| 3,246,630 | Dearing | April 1966 |
| 3,233,588 | Thomas | February 1966 |
| 3,111,932 | Knutson | November 1963 |
| 2,671,427 | Fell | March 1954 |
| 2,592,430 | King | April 1952 |
| 2,390,854 | Thompson | December 1945 |
| 1,970,754 | Jonasen | August 1934 |
| 1,773,141 | Hodgson | August 1930 |

Training Devices and Methods for Training Cats and Animals:

| | | |
|---|---|---|
| 6,341,578 | Berube | January 2002 |
| 5,640,928 | Rhymer | June 1997 |
| 6,273,027 | Watson | November 1999 (animal wears |
| | | electronic collar) |
| 6,371,050 | Machizuki | March 2000 (attractant and |
| | | repellent in litter) |
| 4,437,430 | DeBardeleben | April 1982 |
| 3,688,742 | McGee | September 1972 |
| 2,671,906 | Potts | March 1954 |

Indexed Edges to Enable Things to be Mated Together:

| | | |
|---|---|---|
| 4,181,096 | Grubman | March 1978 |
| 3,428,967 | Hughes | February 1969 |
| 2,893,017 | | |
| 4,231,321 | Cohen | /1980 |
| 4,181,096 | Grubman | January 1980 |
| 2,292,368 | Gordon | August 1942 |
| 2,662,229 | Wentstern | December 1953 |
| 2,584,656 | Anderson | February 1952 |
| 2,204,416 | | |
| 2,073,390 | Giblette | March 1937 |
| 2,053,594 | Albert | /1936 |

Prior Art to Reduce Aperture and Provide Animal Support Platform Above a Water Flush Toilet: (For Human or Animal Use)

| | | |
|---|---|---|
| 6,145,475 | Jackson | November 2000 |
| 6,119,629 | Sicchio | /2000 |
| 5,216,979 | Sallee | /1993 |
| 5,184,574 | Kirk | February 1993 |
| 5,117,780 | Wooten | /1992 |
| 5,103,772 | Schmid | April 1992 |
| 4,747,700 | Wooten | |
| 4,437,430 | DeBArdeleben | March 1984 |
| 4,271,544 | Hammond | |
| 4,231,321 | Cohen | /1980 |
| 4,181,096 | Grubman | January 1980 |
| 2,584,656 | Anderson | February 1952 |
| 2,251,039 | DaSilva | July 1941 |
| 2,204,416 | | |
| 2,053,594 | Albert | /1936 |
| 6,418,880 | Chiu | July 2002 |
| 6,145,475 | Jackson | November 2000 |
| 6,014,946 | Rhymer | June 1997 |
| 5,622,139 | Rhymer | April 1997 |
| 5,458,089 | Rhymer | October 1995 |
| 4,262,634 | Piccone | April 1981 |
| 3,949,429 | Hall | April 1976 |
| 3,757,738 | Hall | January 1973 |
| 3,752,121 | Brazzell | August 1973 |
| 3,608,741 | Thompson | September 1972 |
| 3,603,290 | O'Rork | September 1971 |

Permanent Plumbing Installations (of Housings, Platforms, Posts for Toileting Use by Animals) that have Water Flushing Means and Discharge to Sewage Systems, But not Adequate and Automatic Cleaning:

| | | |
|---|---|---|
| 6,561,132 | Gordon | May 2003 (with washable litter) |
| 6,561,131 | | |
| 6,457,435 | Bridges | October 2002 |
| 6,453,844 | Janzen | September 2002 |
| 5,996,533 | Gordon | December 1999 (washable litter) |
| 5,791,288 | Ehrler | August 1998 (washable, magnetic litter) |
| 5,458,090 | Favreau | October 1995 |
| 4,729,349 | Loctin | March 1988 |
| 4,593,645 | Dingler | June 1986 (washable litter) |
| 4,228,544 | Tumminaro | October 1980 |
| 4,117,555 | Dennis | October 1978 |
| 4,011,836 | Temel | October 1991 |
| 3,964,437 | Brown | June 1976 |
| 3,921,582 | Sedlmeir | November 1975 |
| 3,827,401 | Franzl | August 1974 |
| 3,817,213 | Chalmers | January 1974 |
| 3,811,410 | Roberts | May 1974 |
| 3,793,987 | Rogers | February 1974 |
| 3,747,563 | | |
| 3,734,057 | Lee | May 1973 |
| 3/603.290 | Rork | September 1971 |
| 3,324,828 | Johnson | June 1967 |
| 3,318285 | Betham | September 1967 |
| 2,883,963 | Scott | April 1959 |
| 2,204,416 | | |
| 2,182,980 | Bruzenak | December 1939 |
| 1,813,329 | Supplee | |

Toilets that Clean Primarily with Mechanical Means, not Liquid Flush and which Provide Inadequate Cleaning:

| | | |
|---|---|---|
| 6,615,765 | Thomas | September 2003 |
| 4,242,763 | Walker | |
| 4,196,693 | Universaw | April 1980 |
| 4,098,224 | Hayes | July 1978 |
| 4,050,414 | Knochel | May 1976 |
| 3,871,331 | Breau | |
| 3,771,491 | Hunter | |
| 3,747,563 | Brockhouse | July 1973 |
| 3,227,138 | Campbell | September 1964 |
| 3,318,285 | Betham | |
| 2,946,065 | Smith | July 1960 |
| 2,204,416 | Kramer | |

Flush Valves to Provide Liquids for Flushing Action:

| | | |
|---|---|---|
| 20030145370 | Lee | August 2003 |
| 20040040076 | Han | March 2004 |
| 4,233,698 | Sloan | |
| 2,677,141 | Filliung | September 1954 |

Toilet Inlet Holes that Improve Flushing and Water Conservation:

| | | |
|---|---|---|
| 20040040076 | Unkyung | July 2004 |
| 20040040080 | Prokopenko | March 2004 |
| 20030213055 | Yoneda | November 2003 |

Those skilled in the art will see that certain modifications can be made to the apparatus and methods disclosed in the illustrated embodiments, without departing from the spirit of the invention. This invention has been described with respect to the preferred embodiments, but it is understood that the invention is adaptable to numerous rearrangements, modifications and alterations. All such rearrangements, modifications and alterations are intended to be within the scope of these claims.

Having described the invention, I claim to have invented:

1. An animal toilet assembly, adapted to fit above a waste receiving means, said animal toilet assembly having multiple functional component modules, interconnected to form said animal toilet assembly, said animal toilet assembly comprising, in combination:
a) A toilet fixture module, having a receptacle adapted to receive animal waste, said receptacle having a top aperture, said top aperture having a perimeter thereabout, and said toilet fixture having a waste outlet, adapted to interface with the waste receiving means, said outlet defining a discharge passageway for discharging waste materials from said toilet receptacle and to the waste receiving means, and having a platform interface, extending functionally around said perimeter of said top aperture; and
b) A platform module, having an outer rim means, adapted to interface on said toilet receptacle, an aperture, adapted to receive and pass-through waste material from an animal using said animal toilet assembly, and means to support the animal, while the animal is using said toilet assembly.

2. An animal toilet assembly, as in claim 1, and comprising means, integral with said animal toilet assembly, for removing waste from said receptacle.

3. An animal toilet assembly, as in claim 1, and comprising means to introduce liquids and fluids into said receptacle, and means for flushing and cleaning waste materials from said receptacle.

4. An animal toilet assembly, as in claim 1, and including composting disposal means, adapted to compost waste materials received in said receptacle.

5. An animal toilet assembly, as in claim 1, and including incineration disposal means, adapted to incinerate animal waste.

6. An animal toilet assembly, as in claim 1, and including an insert adapted to be received onto said platform and above said apertures in said platform.

7. An animal toilet assembly, as in claim 1, and including an insert adapted to index into said platform module and assembly system, and to be supported by said animal support means, said insert being adapted to restrict the size of said apertures in said platform module when said insert is so positioned with respect to said platform.
